(19) United States
(12) Patent Application Publication
(10) Pub. No.: US 2026/0356666 A1
(43) Pub. Date: Nov. 12, 2026

(54) FEEDSTOCK FLEXIBILITY FOR TRI-CONVERTER REACTOR

(71) Applicant: Aether Fuels Pte. Ltd., Singapore (SG)

(72) Inventors: Conor F. Madigan, Chicago, IL (US); Claudio Bertelli, Chicago, IL (US)

(73) Assignee: Aether Fuels Pte. Ltd., Singapore (SG)

(21) Appl. No.: 19/670,335

(22) Filed: May 7, 2026

Related U.S. Application Data
(60) Provisional application No. 63/802,124, filed on May 8, 2025.

(51) Int. Cl. C01B 3/34; B01J 8/00; B01J 8/02

(52) U.S. Cl. CPC C01B 3/34; B01J 8/001; B01J 8/0278; B01J 8/0285; B01J 2208/00097; B01J 2208/00628; B01J 2208/00725; C01B 2203/0233; C01B 2203/0238; C01B 2203/1241; C01B 2203/1623

(57) ABSTRACT

Methods of making syngas, and making chemical products from syngas, are described herein. A direct conversion syngas reactor is used to convert methane, carbon dioxide, hydrogen, other hydrocarbons or any combination of these to syngas. Where hydrogen availability is variable, methods and apparatus are described herein to produce syngas in a direct conversion syngas reactor while varying feed component compositions and reaction conditions to achieve target effluent properties.

### CROSS REFERENCE TO RELATED APPLICATIONS

This application for patent claims priority benefit of U.S. Provisional Patent Application No. 63/802,124, filed May 8, 2025, which is entirely incorporated herein by reference.

### BACKGROUND

Technologies are being developed for making chemical products using renewable and sustainable sources of carbon. Such processes often comprise converting some combination of methane, carbon dioxide, and hydrogen into syngas, a mixture of carbon monoxide and hydrogen, which can be used as an input to chemical products manufacture processes such as Fischer-Tropsch processes. Using renewable raw materials, when available, particularly biogenic methane and hydrogen produced via electrolysis from water and renewable power, minimizes the total environmental burden associated with making such chemical products. Renewable raw materials such as hydrogen and methane are not always continuously available in reliable quantities for stable conversion into chemical products, so there is a need for a flexible chemical manufacturing process that can use time varying amounts of renewable raw materials.

### SUMMARY

Embodiments described herein provide a method, comprising performing a conversion process that converts a combination of methane, carbon dioxide, hydrogen, and water in an input gas to syngas in a direct conversion syngas reactor; determining an availability of hydrogen from renewable sources; providing hydrogen from renewable sources to the direct conversion syngas reactor in the input gas for the conversion process based on the availability; and controlling a thermal condition of the conversion process based on the availability.

Other embodiments described herein provide a method, comprising performing a conversion process that converts a combination of methane, carbon dioxide, hydrogen, and water in an input gas to syngas in a direct conversion syngas reactor; determining an availability of hydrogen from renewable sources; determining a target concentration of methane, carbon dioxide, and water in the input gas to the direct conversion syngas reactor based on the availability of hydrogen; providing hydrogen from renewable sources to the direct conversion syngas reactor for the conversion process based on the availability; providing methane, carbon dioxide, and water to the direct conversion syngas reactor for the conversion process based on the target concentrations; and controlling a thermal condition of the conversion process based on the availability.

Other embodiments described herein provide a method, comprising performing a conversion process that converts a combination of methane, carbon dioxide, hydrogen, and water in an input gas to syngas in a direct conversion syngas reactor; determining an availability of hydrogen from renewable sources; determining a target concentration of methane, carbon dioxide, and water in the input gas to the direct conversion syngas reactor based on the availability of hydrogen and a target flow rate and/or composition of the syngas; providing hydrogen from renewable sources to the direct conversion syngas reactor for the conversion process based on the availability; providing methane, carbon dioxide, and water to the direct conversion syngas reactor for the conversion process based on the target concentrations; using a reaction model to define a target thermal condition for the conversion process based on the target concentrations of methane, carbon dioxide, and water in the input gas and based on a target concentration in an effluent of the direct conversion syngas reactor; and controlling a thermal condition of the conversion process to the target thermal condition.

Other embodiments described herein provide a method, comprising performing a conversion process that converts a combination of methane, carbon dioxide, hydrogen, and water in an input gas to syngas in a direct conversion syngas reactor; determining an availability of hydrogen from renewable sources; determining a target concentration of methane, carbon dioxide, and water in the input gas to the direct conversion syngas reactor based on the availability of hydrogen and a target composition of the syngas; providing hydrogen from renewable sources to the direct conversion syngas reactor for the conversion process based on the availability; providing methane, carbon dioxide, and water to the direct conversion syngas reactor for the conversion process based on the target concentrations; and responding to a change in the availability of hydrogen by adjusting the target concentrations to control a flow rate of the syngas and to control a composition of the syngas based on the target composition.

### BRIEF DESCRIPTION OF THE DRAWINGS

FIG. 1 is a process diagram of a carbon material conversion process according to one embodiment.

FIG. 2 is a process diagram of a carbon material conversion process according to another embodiment.

### DETAILED DESCRIPTION

Methods and apparatus are described herein for producing synthesis gas (“syngas”) using a Tri-Converter™ reactor. A Tri-Converter reactor is a direct conversion syngas reactor that can stably directly convert methane, carbon dioxide, via both steam reforming, the conversion of CH₄ and steam (i.e. water) into CO and H₂, and dry reforming, the conversion of CH₄ and CO₂ into CO and H₂. A Tri-Converter reactor can also perform a third reaction, the Water Gas Shift (WGS)—Reverse Water Gas Shift (RWGS) reaction (often referred to in this context, where the reaction is configured to net convert CO₂ into CO, as just RWGS), wherein CO₂ and H₂ react to form CO and H₂O, and CO and H₂O may react to form CO₂ and H₂. For an input feed having a suitable composition, the syngas produced by a Tri-Converter reactor has ratio of H₂ to CO, usually between about 1.5 and 2.5 depending on input feed composition and the reactor temperature and pressure, that is attractive for chemical product manufacture using Fischer-Tropsch methods. This ratio can be tuned by adjusting the input feed composition (e.g. the stream composition relative to the other components) and by adjusting the temperature and pressure (which shift the thermodynamic equilibrium of the various reactions).

The Tri-Converter reactor comprises one or more elongated pressure vessels such as drums or tubes, that each contain a bed of catalyst, in combination with a heat delivery system that delivers heat into each of the catalyst beds. The catalyst may be housed in one or more internal structures within the reactor such as tubes or walled zones. The heat delivery system provides the necessary heat to: (a) heat the input feed up to the desired process temperature (in the case that the feed enters at a temperature below that desired process temperature); and (b) replace the heat consumed by the Tri-Converter reaction, which is in general net endothermic.

The Tri-Converter catalyst bed may comprise a single heterogeneous catalyst, e.g. a noble metal on an oxide support, or multiple catalysts, e.g. a first catalyst comprising a noble metal on an oxide support and a second catalyst. The catalyst bed has stable activity for steam methane reforming, as CH₄+H₂O [symbol] CO+3H₂, dry reforming, as CH₄+CO₂ [symbol] 2CO+2H₂, and RWGS, as H₂+CO₂ [symbol] CO+H₂O.

Conventional catalysts used for steam methane reforming do not have good stability for dry reforming, and thus conventionally the feed and process conditions are selected to suppress dry reforming (e.g. by minimizing CO₂ in the feed and/or utilizing high amounts of steam so that the steam reforming reaction dominates) but such methods may form syngas that is suboptimal for downstream chemical product manufacture, e.g. having a ratio of H₂ to CO that is typically above 2.5, where the preferred ratio for chemical product manufacture is between 1.5 and 2.5. Such methods can also be suboptimal where it is desired to convert CO₂ as a reactant, in the input feed, into syngas.

In addition to methane, CO₂, and steam, one can also provide H₂ as an input to the Tri-Converter reactor. As noted above, the RWGS can occur, and one can introduce H₂ as an input to shift the thermodynamic equilibrium of the reaction and convert more of the CO₂ in the input feed. In one embodiment of a process using a Tri-Converter reactor, it is even possible to supply only CO₂ and H₂ as input and use the Tri-Converter reactor primarily as a RWGS reactor to convert CO₂ into CO.

The heat delivery system of the Tri-Converter reactor may utilize conventional combustion based heating, frequently referred to as “firing,” so that such a reactor is sometimes called a “fired reactor.” In such cases, a fuel is supplied to the heating system and is combusted using a “burner” to produce a heat source in the form of a flame, that provides both radiative heat as well as conductive heat via the flow of hot flue gas produced by the fuel combustion process. Where the catalyst bed is housed in an internal structure such as tubes, the tubes absorb radiant heat, and the hot flue gas flows over and around the tube transferring heat from the gas into the tube via conduction. The hot tubes then transmit the heat into the catalyst bed. In such systems, critical thermal parameters of the process can include the temperature of the catalyst bed, the tube wall, and the flame, and can also include the thermal flux (i.e. the flow of thermal energy) into the catalyst bed, into catalyst tube wall, and out of the flame. Such flux may be defined in terms of energy flow per time and per area. The delivery of energy to the heat source in such case may be measured by fuel flow rate, e.g. as energy per time (e.g. mmBtu/hr or MJ/hr or MW) to the burner. The delivery of energy from the heat source into the catalyst bed may also be measured as energy per time.

Alternatively, the heat delivery system of the Tri-Converter reactor may utilize electrical-based heating, wherein electric heating elements that convert electrical current and voltage into heat, such as resistive heating elements or inductive heating elements, are configured to generate heat that is then delivered into the catalyst bed. The heat delivery system may have multiple sections, wherein different heat fluxes can be delivered to the catalyst bed in each section to control the temperature in the catalyst bed in each section more precisely. Where the catalyst bed is housed in an internal structure such as tubes, the tubes may absorb heat from the heating elements via radiation or conduction, depending on the reactor configuration. The hot tubes then transmit that heat into the catalyst of the catalyst bed. Alternatively, the catalyst bed may be housed in a large structure containing heating elements distributed within the catalyst of the catalyst bed. Such heating elements may be disposed inside tubes, which may be in direct contact with the catalyst of the catalyst bed, or the heating elements may themselves be in direct contact with the catalyst of the catalyst bed. In such systems, critical thermal parameters of the process can include the temperature of the catalyst bed (e.g. temperature of the catalyst in the catalyst bed), the temperature of the gas, the tube wall temperature (for configurations having tubes), and the heating element temperature. Each of these critical parameters can include values that are averaged over the tube or specified at particular points, for example, averaged over a certain section of the tube length (e.g. over each, i.e. first, second, and third, third of the catalyst bed) or at a certain point (e.g. the entrance of the catalyst bed, the mid-point of the catalyst bed, or the exit of the catalyst bed). Critical thermal parameters, in such systems, can also include the total thermal energy flow (i.e thermal energy per unit time) into the catalyst bed volume, into the exterior tube wall surface (for configurations having tubes), and out of the heating element(s), and the thermal energy flow into a specific volume or the thermal energy flux (i.e. the thermal energy flow through a unit surface area) at a certain point flow. For parts of the system having a defined surface area (e.g. the bounding surface of the catalyst bed or the exterior tube wall), a total thermal energy flux (i.e. thermal energy flow per unit area) may be defined as the total thermal energy flow divided by the relevant surface area. The delivery of energy to the heating element in such case may be measured by electrical power, e.g. in terms of MW or amperage at a given voltage. As noted above, the Tri-Converter reactor can be controlled, and provided with a blend of feedstocks, to yield syngas having a favorable molar ratio of H₂ to CO for chemical product manufacture, which is typically a ratio of about 1.5 to 2.5.

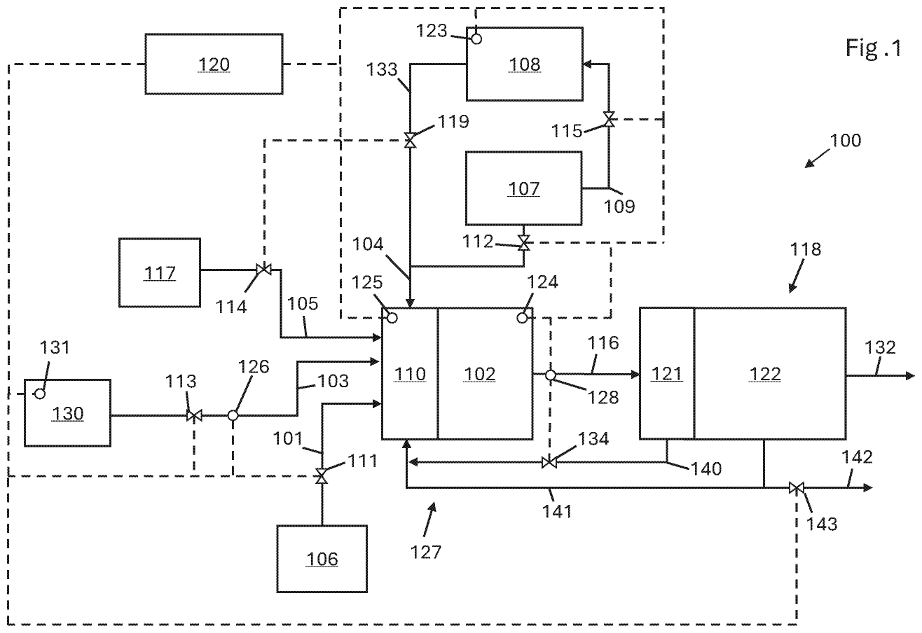

Methods described herein use a flexible feedstock system to provide raw material reactant gases to a direct conversion syngas reactor like the Tri-Converter reactor. FIG. 1 is a process diagram of a process 100 according to one embodiment. A direct conversion syngas reactor 102 is used to convert methane, carbon dioxide, hydrogen, steam, or any combination thereof into a mixture of hydrogen and carbon monoxide, called synthesis gas or “syngas,” for use in making other chemical products. Optionally, the feed may contain hydrocarbons other than methane, e.g. ethane, propane, etc. The direct conversion syngas reactor 102 can stably and directly convert a carbon feed containing CH₄, and/or CO₂ into syngas using reforming reactions. In addition to CH₄ and CO₂, hydrogen can be provided to the reactor 102 in a hydrogen feed 103 from a hydrogen source 130. Water can also be provided to the reactor 102, usually as steam, from a steam source 117. Usually, all the feeds are mixed and provided to the reactor 102 in any suitable configuration.

The process 100 has a syngas stage 127 that includes the reactor 102. The syngas stage 127 generally produces syngas from the various materials provided to the reactor 102. The syngas emerges from the syngas stage 127 in an effluent 116. The syngas stage 127 can include a reactor feed conditioner 110. The various feeds can be provided to the syngas stage 127 at the reactor feed conditioner 110, directly to the reactor 102, or both, or at any other suitable location of the syngas stage 127. Here, the feeds are provided to the reactor feed conditioner 110. The reactor feed conditioner 110 conditions the feed before it is provided to the reactor 102. Such conditioning may include preheating and/or pre-reforming one or more of the gas feeds, and/or mixing of the gas feeds so as to ensure a uniform gas composition upon entry into reactor 102. In this context, pre-reforming refers to the conversion of some or all of the molecules in the feed (if any) that contain two or more carbon atoms into mixtures of H₂, CO, CO₂, and CH₄ prior to the feed reaching the reactor 102.

Generally, the direct conversion syngas reactor 102 can perform three chemical reactions, in virtually any combination depending on the reaction conditions and raw materials, as follows:

CH₄+H₂O [symbol] CO+3H₂ (1) Steam Reforming;

CH₄+CO₂ [symbol] 2CO+2H₂ (2) Dry Reforming;

CO+H₂O [symbol] CO₂+H₂ (3) Water-Gas Shift.

The syngas produced by a direct conversion syngas reactor, from an appropriate feed stream, has an attractive ratio of H₂ to CO, usually a molar ratio between about 1.5 and 2.5 suitable for chemical product manufacture using Fischer-Tropsch methods or other chemicals manufacturing methods. This ratio can be tuned by adjusting the input feed composition, e.g. the mix and quantity of components in the feed, and by adjusting the temperature and pressure, which affect the thermodynamic equilibrium of the various reactions. Thus, where the objective is to produce a mixture of H₂ and CO, a feed to the reactor 102 can contain CH₄, which can be converted using reactions (1) and (2) above, and/or CO₂, which can be converted using reaction (2) or by the reverse direction of reaction (3), as written above.

The carbon feeds can be methane from a methane source 106 and/or carbon dioxide from a carbon dioxide source 107. When methane is used, the methane is provided to the reactor 102 in a methane feed 101. When carbon dioxide is used, the carbon dioxide is provided to the reactor 102 in a carbon dioxide feed 104. The process 100 can produce syngas partially or entirely from renewable sources and/or sources with no environmental burden. The methane source 106 can be a biogas plant or other renewable methane source. The methane source 106 can be a network methane source, such as a renewable natural gas network. The methane source 106 can be supplied by a physical pipeline network carrying methane from one or more sources, which can be renewable sources, to source 106. The methane source 106 can be supplied by trucks, barges, or ships from one or more sources, which can be renewable sources, to source 106. The methane source 106 can be supplied by a combination of one or more physical pipeline networks and one or more trucks, barges, or ships. In general, renewable methane sources can comprise, without limitation, waste water treatment plants, landfills with landfill gas capture systems, diary waste digestors, agricultural waste digesters, food waste digesters, and palm oil mill effluent treatment plants with biogas capture systems. Carbon dioxide can be obtained directly from air, from combustion flue gas, or from storage. A carbon dioxide storage 108 can be used to store carbon dioxide and/or to supply carbon dioxide to the syngas stage 127. The carbon dioxide source 107 can be fluidly coupled to the carbon dioxide storage by a storage fill conduit 109. The carbon dioxide storage 108 can be fluidly coupled to the syngas stage 127 by a storage withdrawal conduit 133. In most cases, the storage withdrawal conduit 133 merges with the carbon dioxide feed 104 to supply carbon dioxide to the syngas stage 127. Hydrogen can be obtained via electrolysis using renewable power such as wind or solar power, or from other sources.

Where hydrogen is available, hydrogen can be provided to a direct conversion syngas reactor, like the reactor 102, along with methane, water, and carbon dioxide to influence the equilibrium composition of the reaction mixture given the reactions above. Supplying hydrogen to the reactor, optionally in excess, can drive the steam reforming and dry reforming reactions above to the left, suppressing the conversion of methane. With carbon monoxide and carbon dioxide on both sides of the reactions above, supplying excess hydrogen to the reaction mixture will affect the presence of carbon monoxide and carbon dioxide according to the rates of the individual reactions depending on temperature of the reaction mixture since the reactions proceed at different rates according to different rate constants, which have their own individual dependence on temperature. Generally, increasing the amount of hydrogen will reduce the conversion of methane and increase the conversion of CO₂. Where hydrogen is excess, unconverted hydrogen will also be present in the resulting syngas product. Thus, varying hydrogen composition of the reactant mixture in the input feed and temperature in the catalyst bed will affect the composition of the product gas flowing in the effluent 116. The carbon dioxide provided to carbon dioxide source 107 can be provided by a biogas upgrading unit (not shown) that receives biogas and separates it into methane which is provided to methane source 106 and carbon dioxide that is provided to carbon dioxide source 107. In some instances, a biogas feed has more carbon dioxide than can be consumed in a plant solely by the methane in the feed, such that a portion of the carbon dioxide from source 107 is during such times directed to storage 108. At other times, for example when hydrogen is available, such stored carbon dioxide can be supplied by storage 108 for conversion in the plant together with the supplied hydrogen.

Flow control devices can be used to control flow rates of the various feeds to the syngas stage 127. The flow control devices can be manually operated or remotely operated devices. Control valves or remotely operated valves are commonly used. A first flow control device 111 is coupled to the methane feed 101. A second flow control device 112 is coupled to the carbon dioxide feed 104 from the carbon dioxide source 107. A third flow control device 113 is coupled to the hydrogen feed 103. A fourth flow control device 114 is coupled to the steam feed 105. A controller 120 can be operatively coupled to the flow control devices 111, 112, 113, and 114 to send signals that adjust the flow control devices to control the flow rates of the feeds to the syngas stage 127. A fifth flow control device 115 can be coupled to the storage fill conduit 109 and operatively coupled to the controller 120 to allow the controller 120 to control a flow rate of carbon dioxide from the carbon dioxide source 107 to the storage 108. A sixth flow control device 119 can be coupled to the storage return conduit 133 to control a flow rate of carbon dioxide from the storage 108 to the syngas stage 127.

The controller 120 is typically a digital processing system that has one or more digital processor, memory, and input/output devices such as network devices, display devices, and storage devices connected to the digital processor and memory. The controller 120 is configured using software instructions that cause the controller to input and output signals as described herein. The software instructions can also cause the controller to perform calculations that might be useful in monitoring and/or controlling the process 100.

The controller 120 can be operatively coupled to the fifth and sixth flow control devices 115 and 119 to control flows of carbon dioxide to and from the storage 108. The controller 120 can be configured to adjust the flow control devices 112, 109 and 119 to control filling and removal of carbon dioxide in the storage 108 while monitoring the amount carbon dioxide stored, and the remaining available capacity, in 108 and maintaining a target flow of carbon dioxide to the syngas stage 127. For example, as availability of carbon dioxide from the carbon dioxide source 107 varies, the controller 120 can be configured to increase and decrease flow of carbon dioxide from the storage 108 to compensate. Where inventory of carbon dioxide in the storage 108 is low, the controller 120 can be configured to adjust the fifth and/or sixth flow control devices 115 and 119 to increase the amount of carbon dioxide in the storage 108. A storage sensor unit 123 can be coupled to the storage 108 to sense one or more conditions of the storage 108 and to provide signals representing the one or more conditions. The storage sensor unit 123 can include one or more sensors to sense, and to output signals representing, temperature, pressure, quantity, and/or composition, of material within the storage 108. The controller 120 can be operatively coupled to the storage sensor unit 123 and configured to receive the signals and to resolve the conditions represented by the signals. The controller 120 can also be configured to send control signals to the flow control devices 112, 115, and 119 based on the signals received from the storage sensor unit 123. In one example, the controller 120 is configured to maintain a target flow of carbon dioxide to the syngas stage 127 while adjusting the flow control devices 115 and 119 to achieve a target amount of carbon dioxide in the storage 108. Thus, the controller 120 can be configured to adjust the flow control device 115 to set a first flow and the flow control device 119 to set a second flow, where the first flow is greater than the second flow if a signal from the sensor unit 123 indicates that a quantity of carbon dioxide in the storage 108 is below a target or a target range, and the first flow is less than the second flow if a signal from the sensor unit 123 indicates that the quantity of carbon dioxide in the storage 108 is above the target or target range.

The effluent 116 from the syngas stage 127 routes the product gas of the reactor 102, which contains syngas, to a conversion stage 118 for conversion to chemical products such as hydrocarbons, alcohols, and the like. The conversion stage 118 comprises a conversion unit 122, which may be based on Fischer-Tropsch chemistry, gas-to-methanol chemistry, or other syngas conversion chemistries, or combinations thereof. The conversion stage 118 may optionally include a conversion conditioner 121 to condition feed for the conversion unit 122. The conversion conditioner 121 may adjust one or more of composition or thermodynamic condition of the syngas prior to conversion in the conversion unit 122. The conversion conditioner 121 can be one unit or a plurality of units that change one or more conditions of the syngas. The conversion conditioner 121 can include a cooler, a condenser, a compressor, an acid gas removal unit, or any combination thereof.

The conversion stage 118 yields a product stream 132 that can be, or include, any organic or inorganic chemical product that can be made using syngas as a raw material. Such products can be, or can include, hydrocarbons, alcohols, ammonia, and any other chemical products that can be made from hydrocarbons, alcohols, and/or ammonia.

Conversion unit 122 may produce off gases, for example, light hydrocarbons and unconverted syngas, which may optionally be recycled to the syngas stage 127. The off gases may be produced by the conversion unit 122 and/or by the conversion conditioner 121. For example, the conversion conditioner 121 may remove some components of the product gas of the syngas stage 127 to achieve a target composition of feed gas for the conversion unit 122. Components such as hydrogen, carbon monoxide, carbon dioxide, unreacted methane, and other impurities can be removed by the conversion conditioner 121. A first recycle 140 may be provided to recycle such components to the syngas stage 127, for example to recover, and improve conversion of, carbon containing species such as methane and carbon dioxide. Here, the first recycle 140 couples an effluent of the conversion conditioner 121 to the reactor feed conditioner 110. A first recycle flow controller 134 is coupled to the first recycle 140 to control flow of off gas recovered from the conversion conditioner 121 to the syngas stage 127. The first recycle flow controller 134 can be operatively coupled to the controller 120 to receive control signals from the controller 120 for adjusting a flow rate of gas within the first recycle 140. The conversion unit 122 can also produce off gases, which may include hydrocarbons, hydrogen, carbon monoxide, carbon dioxide, and other organic and inorganic components. A second recycle 141 may be provided to recycle such components to the syngas stage 127. A purge 142 can be coupled to the second recycle 141 to allow removal of unwanted components, such as, for example, inert gases. A purge flow controller 143 is coupled to the purge 142, in this case, to control a flow rate of gas in the purge 142. The purge flow controller 143, in this case, also exerts control over a flow rate of gas in the second recycle 141. The purge flow controller 143 can be operatively coupled to the controller 120 to receive control signals from the controller 120 for adjusting the flow rate of gas in the purge 142 and/or the second recycle 141.

The controller 120 may be configured to adjust the first recycle flow controller 134 to achieve one or more target conditions of the feed to the syngas stage 127. The target conditions can include temperature, pressure, flow rate, composition, and any parameter derived therefrom, which may be computed by the controller 120. The controller 120 may also, or instead, be configured to adjust the second recycle flow controller 143 to achieve one or more target conditions of the feed to the syngas stage 127 in similar fashion. Conversion conditioner 121 may separate out, or produce, gases that are not provided to conversion unit 122 and not recycled to syngas stage 127, in which case these excess gases may be exhausted from the plant. For clarity, such exhaust stream is not shown in the figure.

All the flow controllers 111-115, 119, 134, and 143 may include flow sensors to sense a flow rate at the location of the respective flow controllers. The flow sensors can output signals representing the respective flow rates, and the controller 120 can be configured to receive the signals and resolve the flow rates from the received signals. In other cases, flow sensors that are separate from the flow controllers 111-115, 119, 134, and 143 may be coupled to the various flow conduits at suitable locations to sense flow rates and provide signals representing the flow rates to the controller 120, to the flow controllers 111-115, 119, 134, and 143, or both.

A first sensor unit 124 is coupled to the reactor 102 to sense one or more conditions of the reactor 102 and to provide signals representing the one or more conditions. The first sensor unit 124 can have one sensor or a plurality of sensors, which can be, or can include, one or more thermal sensors, one or more electrical current and/or voltage sensors, one or more pressure sensors, one or more flow sensors, and/or one or more composition sensors, any of which can be mechanical or electromagnetic in nature. More than one of each sensor can be used, and multiple types of sensors can be used to sense the same condition, or related conditions, to improve reliability. The first sensor unit 124 is shown as being located at one location of the reactor 102, but the first sensor unit 124 may be coupled to the reactor 102 at a plurality of locations, which may be distributed along the longitudinal direction of the reactor 102, the lateral or azimuthal direction of the reactor 102, or both. In one embodiment, the first sensor unit 124 includes a plurality of thermal sensors located at different locations of the reactor 102 to monitor a thermal condition of the reactor at the different locations. The first sensor unit 124 outputs one or more signals representing the condition of the reactor 102 sensed by a sensor of the first sensor unit 124. The first sensor unit 124 may be coupled to the outside of the reactor 102, or may be located within the reactor, such as coupled to a structure, such as a catalyst bed, a catalyst container, a mixing structure, or an interior wall, within the reactor 102. The controller 120 may be operatively coupled to the first sensor unit 124 to receive signals output from the first sensor unit 124 and may be configured to determine, from the signals, a thermal condition, such as temperature, thermal flow, thermal flux, or changes in temperature and/or thermal flow and/or thermal flux, of the reactor 102. In one embodiment, first sensor unit 124 comprises a sensor for determining the current through, the voltage drop over, and/or the electrical power supplied to one or more electrical heating elements producing heat utilized by reactor 102. In one embodiment, first sensor unit 124 comprises a sensor for determining the temperature, pressure, flow rate, and/or composition of the gas flowing from the reactor feed conditioner 110 into the reactor 102. In one embodiment, first sensor unit 124 comprises a sensor for determining the temperature, pressure, flow rate, and/or composition of the gas near to the exit of the catalyst bed in the reactor 102. The controller 120 can be configured to receive signals from the sensor unit 124 representing a composition of the gas flowing from the reactor feed conditioner 110 into the reactor 102 and to infer, for example compute, the gas composition from the received signals. In another embodiment, controller 120 is configured to infer, for example compute, the composition of the gas flowing from the first feed conditioning stage 110 into the reactor 102 based on the flow rates of the various flow controllers 111-115, 119, 134, and 143.

A second sensor unit 126 may be coupled to the hydrogen feed 103 to monitor one or more conditions of the hydrogen feed 103. Like the first sensor unit 124, the second sensor unit 126 can have one sensor or a plurality of sensors, which may be any of the types of sensors described above in reference to the first sensor unit 124. In one embodiment, the second sensor unit 126 contains a flow sensor and a pressure sensor, which can be used to monitor flow rate and pressure of the hydrogen feed 103. More than one of such sensors, which may be different types of such sensors, can be used for improved reliability. Similarly, a third sensor unit 131 may be coupled to the hydrogen source 130 to monitor one or more conditions of the hydrogen of the hydrogen source 130. The third sensor unit 131 may have one sensor or a plurality of sensors, which may be any of the types of sensors described above in reference to the first sensor unit 124 or the second sensor unit 126. In one embodiment, the hydrogen source 130 may be, or may include, a hydrogen storage or buffer vessel, which may be a tank, drum, tube, or other suitable structure, and the third sensor unit 131 outputs a signal representing an amount of hydrogen in the storage or buffer vessel. The hydrogen source 130 may store hydrogen in any suitable form, such as gaseous or liquid hydrogen, or solid or liquid hydrogen derivatives. The third sensor unit 131 senses a condition of the hydrogen source 130 and can output a signal representing an availability of hydrogen, which may be an amount of hydrogen in the hydrogen source 130, a rate of change of an amount of hydrogen in the hydrogen source 130, or any suitable quantity. For example, the third sensor unit 131 may include a pressure sensor for monitoring a pressure of the hydrogen in the hydrogen source 130.

The second and third sensor units 126 and 131, and the third flow control device 113, may be operatively coupled to the controller 120 to send and receive signals representing conditions of the hydrogen source 130 and hydrogen feed 103. For example, the controller 120 may be configured to determine pressure of the hydrogen feed 103 from signals of the second sensor unit 126. The controller 120 may also be configured to control the third flow control device 113, based on the signals from the second sensor unit 126, to maintain a target flow of hydrogen in the hydrogen feed 103. The controller 120 may also be configured to control the flow control device 113 in response to a signal from third sensor unit 131 indicating that hydrogen feed availability has declined, for example, because the flow into a buffer or storage vessel has been reduced or because the amount of hydrogen in the buffer or storage vessel has fallen below a threshold. The controller 120 may also be configured to adjust operation of the syngas stage 127, for example a thermal condition (such as the temperature of a heater, the gas, or the catalyst bed, the thermal flow or flux from one or more heating elements to the catalyst bed or gas, or the amount of energy supplied to one or more heating elements where such energy can be electrical energy for electrical heaters or fuel gas energy for fired heaters) at one or more locations of the reactor 102 and/or the reactor feed conditioner 110, based on signals from the second sensor unit 126. The controller 120 may further be configured to adjust the flow rates of the carbon dioxide, steam, and/or methane-containing feeds, for example, in response signals indicating that hydrogen flow rate from the hydrogen source 130 has been reduced as a result of declining hydrogen availability, so as to result in a desired composition and flow rate of the gas flowing in the effluent 116. For example, if signals from the second sensor unit 126, third sensor unit 131, or both indicate that availability of hydrogen is declining, for example because the flow control device 113 is being controlled to reduce flow of hydrogen in the hydrogen feed 103, e.g. to maintain pressure of the hydrogen in the hydrogen feed 103 or the hydrogen source 130, the controller 120 may be configured to adjust a thermal condition within the reactor 102 and/or adjust the flow rates of the carbon dioxide, steam, and methane-containing feeds (e.g. by controlling flow control devices 111, 112, 114, 119, 134, 143) to drive equilibrium of the various reactions within the reactor 102, described above, to result in a desired flow rate and composition of the gas flowing in the effluent 116. The second sensor unit 126, the third sensor unit 131, or each of the second sensor unit 126 and the third sensor unit 131 may also include a composition sensor to detect impurities in the gas flowing in the hydrogen feed 103 and to output signals representing amount of such impurities to the controller 120. The controller 120 may be configured to adjust flow of the hydrogen feed 103 based on signals from the third sensor unit 131 representing composition of the gas, and may be configured to stop and start flow of the hydrogen feed 103 based on the signals. The controller 120 may be similarly configured to adjust flows of the methane-containing feed 101, the carbon dioxide feed 104, and the steam feed 105 based on signals representing composition of the gas entering or within the reactor feed conditioner 110 and/or the reactor 102, and may be configured to stop and start such flows based on the signals.

A fourth sensor unit 128 may be coupled to the effluent 116 to monitor one or more conditions of the gas flowing in the effluent 116. Like the first, second, and third sensor units 124, 126, and 131 respectively, the fourth sensor unit 128 can have one sensor or a plurality of sensors, which may be any of the types of sensors described above. In one embodiment, the fourth sensor unit 128 includes gas temperature, gas flow rate, and gas composition sensors (such as chromatographic or spectral sensors). More than one such sensor, which may be more than one type of such sensors, can be used for increased reliability.

A fifth sensor unit 125 may be coupled to the reactor feed conditioner 110 to output signals representing a condition of the reactor feed conditioner 110 or of the material inside the reactor feed conditioner 110. As described elsewhere herein, the fifth sensor unit 125 may include one sensor, or a plurality of sensors, to output signals representing conditions such as temperature, pressure, composition, flow rate, or combination thereof, of the reactor feed conditioner 110 or a material or component therein. The controller 120 may be operatively coupled to the fifth sensor unit 125 to receive the signals output by the sensor unit 125 and may be configured to resolve the conditions represented by the signals. The controller 120 may also be configured to adjust an operating parameter of the reactor feed conditioner 110, and/or adjust any of the flow controllers 111-115, 119, 134, 143 based on the signals from the sensor unit 125. For example, the controller 120 may be configured to adjust control devices of the reactor feed conditioner 110, such as thermal control devices, pressure control devices, and/or flow control devices, to control gas flowing from the reactor feed conditioner 110 to the reactor 102.

In one embodiment, the controller 120 is configured to resolve, based on signals from the first sensor unit 124, a condition of the reaction taking place in the reactor 102. The controller 120 may be configured to determine, from the signals, or even from one signal of the first sensor unit 124, a temperature of the reactor 102, a thermal flow or flux of the reactor 102, a temperature profile of the reactor 102, a thermal flow or flux profile of the reactor 102, a pressure of the reactor 102, a pressure drop of the reactor 102, a flow rate of the reactor 102, a composition of the reactor 102, and/or a composition profile of the reactor 102. The controller 120 may be configured to use a reaction model to determine, based on one or more signals of the sensor units 124, 125, 126, 128, and/or one or more signals provided by flow control devices 113, 111, 112, 114, 119, 134, 143, predicted reaction rates and/or component conversions in the reactor 102. For example, such a reaction model may model the direct conversion syngas reactor as a Gibbs reactor and model the conversions as equal to, or approximately equal to, the conversions at thermodynamic equilibrium, optionally adjusted based on one or more empirically determined correction factors, based on measurements of one or more flow rates, compositions, pressures and temperatures in the reactor 102. For example, the controller 120 may be configured to use a feed composition (which may be computed using signals from the various sensors or directly measured by sensor units 124 and/or 125), the reaction model, and signals from the sensor unit 124 (and/or 125) that directly measure, or can be used to compute, the pressure and temperature of the gas exiting the catalyst bed to predict component conversions in the reactor 102 and the composition of the gas flowing in the effluent 116. Alternatively, or additionally, the controller 120 may be configured to use a target effluent composition, reaction model, and the signals from the first sensor unit 124 and/or fifth sensor unit 125 to predict component conversions in the reactor 102 and target composition of a feed gas to provide to the reactor 102 to obtain the target effluent composition, and may further adjust the various flow controllers 111-115, 119, 134, and/or 143 to achieve the target composition of the feed gas. Alternatively, or additionally, the controller 120 may be configured to use a feed composition, a target effluent composition, the reaction model, and the signals from the first sensor unit 124 to determine a target temperature, thermal flow or flux, temperature profile, and/or thermal flow or flux profile for the reactor 102. Alternatively, or additionally, the controller 120 may be configured to determine a deviation from the target thermal condition, and may be configured to control thermal devices of the reactor 102 to reduce or eliminate the deviation. Models of the reaction systems represented by reactions (1), (2), and (3) above are known.

In another embodiment, the controller 120 is configured to resolve, based on signals from the second sensor unit 126, a rate of hydrogen input to the syngas stage 127, and is configured to use a reaction model to determine, based on the rate of hydrogen input into the syngas stage 127, the signals representing the rate of hydrogen input into the syngas stage 127, or both, a set point for a thermal control device of the reactor 102. For example, the controller 120 may be configured to use a reaction model to determine a target thermal flow rate or thermal flux to achieve a desired reaction temperature or temperature range in the reactor 102 based on the rate of hydrogen input into the syngas stage 127, the signals representing the rate of hydrogen input into the syngas stage 127, or both. Alternatively, or additionally, the controller 120 may adjust the flow rates of the other feed gases in response to the rate of hydrogen input into the syngas stage 127. Alternatively, or additionally, the controller 120 may be configured to determine a target thermal flow rate or thermal flux at a plurality of locations of the reactor 102 so as to achieve a target temperature profile of the reactor 102, based on the rate of hydrogen input into the reactor 102, the signals representing the rate of hydrogen input into the reactor 102, or both. Alternatively, or additionally, the controller 120 may be configured to determine, based on signals from the second sensor unit 126, a set point for hydrogen input into the syngas stage 127 using the hydrogen feed 103. The controller 120 may be configured to control the flow control device 113 to conform the rate of hydrogen input into the syngas stage 127 to the determined set point.

In another embodiment, the controller 120 is configured to resolve, based on signals from the third sensor unit 128, a composition of the gas flowing in the effluent 116, and is configured to use a reaction model to determine, based on the signals from the third sensor unit 128, a condition of the reaction being performed in the reactor 102. The controller 120 may be configured to use recipe information and/or flow rate set points for the feeds to the reactor 102, along with the signals from the third sensor unit 128, in the reaction model to determine the condition of the reaction and/or a target condition of the reaction. Instead of flow rate set points, where the flow control devices 111-114, 119, 134, and 143 are configured to determine actual flow rates of the various feed streams, and where the controller 120 is configured to receive signals from the flow control devices 111-114, 119, 134, and 143 representing the actual flow rates, the controller 120 may be configured to use the signals from the flow control devices 111-114, 119, 134, and 143 representing the actual flow rates of the feeds to the reaction stage 127 in the reaction model.

The sensor units, and/or sensors within the sensor units, may be electromagnetic in nature or physical in nature. Thermal probes used in the sensor units can be radiation-based, resistive, capacitive, pressure-based, or other types of thermal probes. Flow sensors can be based on pressure drop, acoustic probes, friction probes, fan probes, and other gas flow probes. Composition sensors can be spectral, chromatographic, or both. Pressure sensors can be membrane units, piezoelectric units, or other types of pressure sensors.

The controller 120 may be configured to control the reactor 102 to align to any target conditions that may be determined as above. For example, the controller 120 may be configured to determine, using the signals from the third sensor unit 128, along with other information that may include recipe information, flow rate set points, actual flow rates, and other sensor information, such as temperature, pressure, and/or composition information, and using the reaction model, a target temperature, temperature profile, thermal flow or flux, thermal flow or flux profile, flow rate, pressure, pressure profile, and/or composition of the reactor 102. The controller 120 may also be configured to control various control devices of the syngas stage 127, such as heaters and the flow control devices 111-114, 119, 134, and 143 to drive conditions of the reaction being performed in the reactor 102 to meet any determined target conditions. The controller 120 may also be configured to control the various control devices of the reactor 102 to drive conditions of the reaction to user-determined targets.

The controller 120 may be configured to control the flow control device 113 to maintain a target hydrogen flow rate for so long as the hydrogen supply 130 can support such flow rate, and to otherwise reduce, or potentially completely stop, the flow rate in response to signals from sensor units 126 and 131 indicating reduced hydrogen availability. The controller 120 may be further configured to control, based on signals from the second sensor unit 126 representing flow rate of hydrogen to the syngas stage 127, the flow control devices 111, 112, 114, 119, 134, and 143, so as to adjust the methane, carbon dioxide, steam, and recycle gas flow rates, or any subset thereof, to desired targets that depend on the hydrogen flow rate. Alternatively, or in addition, the controller 120 may adjust the flow control devices 111, 112, 114, 119, 134, and 143 to achieve a target effluent syngas composition and flow rate as indicated by signals from the third sensor unit 128, where such targets are based on the flow rate of hydrogen at the flow control device 113, as optionally signalled by the second sensor unit 126. Such effluent syngas targets may be determined to control the syngas composition and flow rate within a preferred operating window for conversion to finished products in the conversion unit 122, and so that the conversion unit 122 can continue operating at a certain minimum capacity despite large changes in hydrogen availability that might result in hydrogen flow rates to the syngas stage 127 that are well below a target level. These two examples show how the composition and flow rate of effluent syngas can be controlled in a direct conversion syngas process fed by carbon dioxide and a time varying hydrogen supply by feeding and adjustable a methane containing feed so as to continue producing syngas with a target composition and a minimum flow rate, in spite of the reductions in the hydrogen feed rate. Using a direct conversion syngas reactor such as a Tri-Converter, given a flow of hydrogen, a flow of methane, carbon dioxide, and steam may be selected to achieve a target syngas composition and a target syngas flow rate, or equivalently, to maintain a minimum syngas rate when hydrogen is not readily available relative to target syngas rate when hydrogen is readily available (e.g. 3 mols/sec vs a target of 4 mols/sec)). Such a minimum syngas rate may be determined based on the maximum acceptable turn-down of syngas feed rate to the downstream processes, e.g. those performed by conversion stage 118, beyond which such processes cannot be reliably and/or efficiently performed. Such a maximum acceptable syngas feed rate turn-down may be, for example, at least 10%, at least 50%, or at least 75% of the target syngas feed rate. In a direct conversion syngas reactor such as the reactor 102, because each of the three reactions (steam reforming, dry reforming, and water gas shift) have different reaction enthalpies, and the prevalence of reactions used to generate each mole of syngas are different depending on the input flow rates, the amount of heat that must be delivered to the direct syngas conversion reactor to maintain the proper reaction conditions can change with change in flow rates of input gases, where such changes in flow rates change the composition of the gas within the reactor.

In all of the examples herein, where a material is described as methane or CH₄, the material can be a natural gas feed, containing a majority CH₄, and a minority of other components, including other light hydrocarbons, such as ethane and propane. Alternatively, such feed can be biogas comprising CH₄ and CO₂, having, for example volumetric or molar ratio of CH₄ to CO₂ of about 1 to about 3, with 1.5 (e.g. 60:40 CH₄:CO₂) to 2 (66:34 CH₄:CO₂) being typical values for biogas. Collectively, the term “methane containing feed” is intended to encompass all such feeds. Where such a material is used as feed to a direct conversion syngas process, such as the process 100, the material might be “pre-reformed” in the reactor feed conditioner 110 prior to providing the material to the direct syngas conversion reactor, such that the other light hydrocarbons are converted into methane, hydrogen, CO₂, and CO. Alternatively, or additionally, a natural gas material can be routed directly into the direct syngas conversion reactor such that reactor feed conditioner 110 does not perform any pre-reforming.

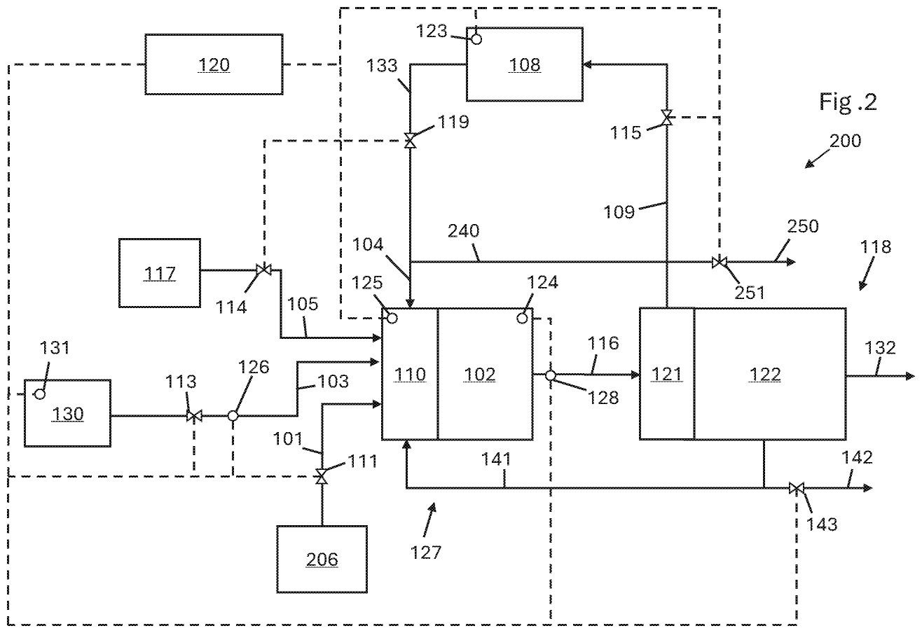

FIG. 2 is a process diagram of a carbon material conversion process 200 according to another embodiment. The process 200 is similar to the process 100, and identical elements of the two processes are labeled using the same numerals. The process 200 differs from the process 100 in implementation of carbon dioxide feed to the syngas stage 127. Where the process 100 uses a separate carbon dioxide source 107 and methane source 101, in the process 200, a methane source 206 is used that includes carbon dioxide, such as a biogas source. Thus, while the methane source 106 may include some carbon dioxide, the amount of carbon dioxide in the methane source 106 is typically, or at least intermittently, insufficient to supply the quantity of carbon dioxide needed for the process 100 so a separate carbon dioxide source 107 is used to supply the needed quantities. In the process 200, the methane source 206 typically has enough, or excess, carbon dioxide, so no separate source of carbon dioxide is provided in the process 200.

Accordingly, in the process 200, the conversion conditioner 121 separates carbon dioxide from the effluent 116 of the syngas stage 127 into a first recycle 240, which routes carbon dioxide separated from the effluent 116 to the carbon dioxide feed 104 to provide carbon dioxide to the syngas stage 127 for inclusion in the feed to the reactor 102. The storage fill conduit 109, in this case, couples the first recycle 240 to the storage 108 to carry separated carbon dioxide to the storage 108. The first recycle 240, in this case, joins with the storage withdrawal conduit 133 to mix carbon dioxide from the storage 108 with carbon dioxide in the first recycle 240. In this case, a purge 250 is coupled to the first recycle 240 to allow removal of a portion of the first recycle 240 in the event, for example, that the storage 108 is full or the material of the first recycle 240 is unsuitable to add to the storage 108. A purge flow controller 251 is coupled to the purge 250, in this case, to control a flow rate of the purge 250. The flow controller 251 is coupled to the controller 120 to receive control signals from the controller 120. The controller 120 is configured to send control signals to the purge flow controller 251 to control the flow rate of the purge 250. The controller 120 can be configured to control the flow rate of the purge 250 based on signals from any of the sensor units 123, 124, 125, 126, 128, and/or 131. In particular, the controller 120 can be configured to control the purge 250 flow rate based on a signal from the storage sensor unit 123 to manage an amount or pressure of gas in the storage 108. The controller 120 can also be configured to control the purge 250 flow rate based on a signal from the fourth sensor unit 128 representing a composition of the gas flowing in the effluent 116, for example to increase the purge 250 flow rate if the composition of the effluent 116 gas indicates a likelihood that gas recovered in the first recycle 240 will be unsuitable for addition to the storage 108. Thus, for example, if an amount of an impurity in the effluent 116 gas rises above a limit, the controller 120 can be configured to increase a flow rate of the purge 250 by adjusting the purge flow controller 251. Also, if an amount of gas in the storage 108 rises above a limit, the controller 120 can be configured to increase a flow rate of the purge 250. If the composition of the effluent 116 gas, indicated by signals from the fourth sensor unit 128, is within a tolerance and the amount of gas in the storage 108, indicated by signals from the storage sensor unit 123, is within a tolerance, the controller 120 can be configured to decrease the flow rate of the purge 250.

The processes 100 and 200 enable methods of making syngas using a direct conversion syngas reactor like the reactor 102. In one method, a conversion process is performed in a syngas stage like the syngas stage 127, which has a direct conversion syngas reactor like the reactor 102. A combination of methane, carbon dioxide, hydrogen, and water is provided to the direct conversion syngas reactor to make syngas. Hydrogen for the conversion process is sourced from renewable sources, which may have variable availability. The availability of the renewable hydrogen for the conversion process is determined, for example by a controller like the controller 120 monitoring signals from a pressure sensor, for example in the second sensor unit 126, and controlling flow rate of a gas containing the hydrogen, for example using a flow control device like the device 113, to maintain pressure of the gas. The availability can also be determined based on signals from a flow sensor, which can be a sensor of the second sensor unit 126. The availability may also be signaled from the hydrogen source 130 itself. The availability, which can be a flow rate representing the time varying maximum flow rate of the gas containing hydrogen that can be provided to the direct conversion syngas reactor, is used to determine the rate that hydrogen from the renewable resource is provided to the reactor.

As concentrations of various species in the reactor change, with the varying availability of hydrogen for the reaction, the equilibrium of the reactions shifts and maintaining an outlet gas having a target concentration can require influencing the equilibrium concentrations using reaction conditions such as temperature and pressure. Because the various reactions are endothermic, for example, adding thermal energy to the reaction can shift the equilibrium of all the reactions to the right, toward the “product” side of the reactions, and vice versa. Thus, a thermal condition of the conversion process is controlled based on the availability of hydrogen from renewable sources to supply to the direct conversion syngas reactor.

In one version, a reaction model is used in controlling the thermal condition of the conversion process. The reaction model can be a physical model, a statistical model, or both, that relates component feed rates and/or concentrations, reaction conditions, and output component rates and/or concentrations or component conversions. For example, the reaction model can treat the direct syngas conversion reactor as a “Gibbs Reactor” in which all reactions are assumed to occur and run to equilibrium based on the input feed composition and a temperature and pressure value determined based on measurements of temperature and pressure in the reactor, for example, a temperature and pressure of the gas at or nearby the exit of the catalyst bed. Such a model can be further modified using empirically determined parameters to correct for non-idealities in the system or measurements. For example, the temperature may be calculated as the temperature of a certain thermocouple in the catalyst bed adjusted by a constant value determined through a system calibration process. The reaction model may be implemented using a digital processor configured to run a machine learning routine that can determine the values of variables used to calculate the relations above. The reaction model can be used to compute component conversions and/or effluent concentrations from feed rates, feed component concentrations, and reaction conditions. Alternatively or additionally, the reaction model can be used to compute optimal reaction conditions from feed rates, feed component concentrations, and conversions, effluent component concentrations, or both. Alternatively or additionally, the reaction model can be used to compute model constants from feed rates and component concentrations, reaction conditions, and effluent component concentrations or component conversions.

The thermal condition in the method above can be a temperature, a temperature profile, a thermal flow or flux, a thermal flow or flux profile, or any combination thereof. Temperatures can be surface temperatures on an outer surface of the reactor, surface temperature at an interior surface of the outer wall of the reactor, surface temperature of an interior structure of the reactor, or a reaction space temperature such as a temperature within a catalyst bed within the reactor. In one case, a surface temperature can be detected at an outer surface of a tube, disposed within the reactor, that contains catalyst for performing the direct conversion syngas reactions. In another case, a temperature of a thermal control element, such as a heater, disposed either outside of or within the reactor can be detected. A temperature profile can be a profile along the longitudinal direction of the reactor, along the radial direction of the reactor, along the azimuthal direction of the reactor, or any combination thereof. The temperature profile can be one-dimensional, two-dimensional, or three-dimensional, and can be time-dependent. A thermal flow is generally a rate of heat input to, or output from, the reactor 102 as a whole or a particular section of the reactor 102. A thermal flux is generally a rate of heat through a unit surface area, for example into or out of a particular volume of reactor 102. The thermal flow or flux can be detected at one location of the reactor, or a thermal flow or flux profile can be inferred, computed, or measured across a plurality of locations of the reactor. Like the temperature and temperature profile readings, the readings used to infer, compute, or measure the thermal flow or flux can be taken at an outer surface of the reactor, at an interior surface of the reactor, in a catalyst bed, or at a thermal control element. Thermal flow or flux profiles can be one-dimensional, two-dimensional, or three-dimensional, and can be time-dependent.

As availability of hydrogen from the hydrogen source changes, flow rates of other feed streams to the direct conversion syngas reactor can be adjusted to maintain a target elemental composition in the reactor. For example, the flow rates of methane, carbon dioxide, and water (steam) can be adjusted to maintain proportions of carbon, hydrogen, and oxygen in the reactor. As the availability of hydrogen from renewable sources is reduced, for example, methane from renewable sources, such as a renewable methane network, can be increased to replace the reduced availability of hydrogen from the renewable source. To offset the increase in carbon, flow of carbon dioxide to the reactor can be reduced. Flow of steam can be adjusted to maintain oxygen balance in the reactor.

As the composition of the reaction gas changes from adjustments to the flow rates of the various molecular species, reaction conditions such as temperature, temperature profile, thermal flux, thermal flux profile, and pressure can be adjusted in the direct syngas conversion reactor. If a sensor unit like the fourth sensor unit 128 is used to signal composition of effluent gas from the reactor, the reaction conditions can be adjusted based on signals from such sensor unit. Alternatively, or additionally, a reaction model can be used to predict changes in effluent composition based on changes in feed composition, and reaction conditions can be ascertained to achieve any desired composition in the effluent gas.

In another method that includes a conversion process like the conversion processes described above, availability of hydrogen from renewable sources is determined, along with target concentration of methane, carbon dioxide, and water in a direct conversion syngas reactor based on the availability of hydrogen. Thus, the target concentrations of methane, carbon dioxide, and water may be determined based on a target elemental composition to provide to the direct conversion syngas reactor, or a target concentration of methane, carbon dioxide, water, and hydrogen may be determined based on a desired effluent composition, and may be adjusted based on the availability of hydrogen. Hydrogen is provided to the conversion process, from renewable sources, based on the availability, and methane, carbon dioxide, and water are provided based on the target concentrations. The thermal condition of the conversion process is controlled based on the availability of hydrogen. As above, a reaction model can be used to determine a target for the thermal condition based on target effluent composition and target feed composition. The reaction model can also use data representing catalyst performance.

As availability of hydrogen from the hydrogen source changes, flow rates of other feed streams to the direct conversion syngas reactor can be adjusted to maintain a composition and flow rate of the syngas effluent within a preferred range for maintaining efficient operation of the conversion stage 118. For example, the flow rates of methane, carbon dioxide, and water (steam) can be adjusted to maintain a ratio of H₂:CO, a flow rate of CO, and an amount of unconverted CO₂ and CH₄, within a predetermined range or a target range. As the availability of hydrogen from renewable sources is reduced, for example, methane from renewable sources, such as a renewable methane network, can be increased to replace the reduced availability of hydrogen from the renewable source. To offset the increase in carbon, flow of carbon dioxide to the reactor can be reduced. Flow of steam can be adjusted to maintain the H₂:CO ratio in the effluent. As the changes above occur over time, a heat flux to the direct conversion syngas reactor can be modified, from a relatively lower heat flux when the hydrogen availability is high to a relatively higher heat flux when the hydrogen availability is low.

Other methods that can be performed using the processes 100 and 200 include a method of operating a manufacturing facility for making chemicals from renewably sourced syngas. This method uses a controller, such as the controller 120, that is configured to maintain a constant flow of syngas to a conversion stage from a syngas stage while an availability of hydrogen for feeding to a reactor like the reactor 102 to make the syngas varies substantially. The controller can be configured to adjust a thermal flux of the reactor between a first configuration for reacting a first mixture of hydrogen, carbon dioxide, and steam, with no methane, and a second configuration, different from the first configuration, for reacting a second mixture of methane, carbon dioxide, and steam, with no hydrogen. The controller is configured to adjust the thermal flux between the first configuration and the second configuration while the feed to the reactor continuously varies between the first mixture and the second mixture, and any composition between the first and second mixtures, to maintain a constant flow of syngas effluent from the reactor. The controller is thus configured to adjust the thermal flux of the reactor to maintain constant flow of syngas in the reactor effluent while feed to the reactor varies between a hydrogen-rich, methane-poor composition and a hydrogen-poor, methane-rich composition. The controller can also be configured to adjust operation of the conversion conditioner as a quantity of carbon dioxide in the reactor effluent varies.

The processes 100 and 200 can be configured to operate in the ways described above. Table 1 shows example conditions of a plant configured to operate at a first condition based on the first mixture above and a second condition based on the second mixture above.

TABLE 1
Conditions of Syngas Swing Plant

| | First Condition | | Second Condition | |
|---|---|---|---|---|
| H₂ Flow Rate (mtpd) | 1.85 | | 0 | |
| CO₂ Flow Rate (mtpd) | 13.1 | | 5.0 | |
| CH₄ Flow Rate (mtpd) | 0 | | 8.5 | |
| Steam Flow Rate (mtpd) | 1.85 | | 12.7 | |
| Syngas Rate (kmol/hr) | 68 | | 117 | |
| H₂ + CO Rate (kmol/hr) | 48.2 | | 96.8 | |
| Syngas H₂ + CO Mole Fraction | 0.708 | | 0.827 | |
| Syngas H₂:CO Molar Ratio | 2.09 | | 2.16 | |
| Reactor 102 Hydraulic Demand | 100% | | 100% | |
| CO₂ Separation Demand | 100% | | 80% | |
| Electric Syngas Generation Unit | 423 | kW | 1759 | kW |
| 102 Heat Duty | | | | |
| Electric Syngas Generation Unit | 900 | C | 900 | C |
| 102 Catalyst Bed Exit | | | | |
| Temperature | | | | |
| Product 132 Output | 3.35 | mtpa | 7.70 | mtpa |

The syngas produced at the two conditions above can be used to produce upgraded Fischer-Tropsch chemical products at rates of 3.35 mtpa for the First Condition and 7.7 mtpa for the Second Condition. This means that in the First Condition, the conversion stage 118 is operated at 50% capacity. It is additionally noteworthy that the reactor 102 hydraulic demand is 100% of the design capacity in both cases, indicating efficient utilization, and similarly the CO₂ separation demand is 100% and 80% of the design capacity in the two cases, again indicating efficient utilization. Table 1 shows that a plant, configured according to the processes 100 or 200, can operate using feed streams with zero hydrogen, zero methane, or intermediate compositions and maintain, in this case, at least 50% utilization of the conversion stage 118 capacity. Where methane content of the feed stream is low, carbon feed is supplemented by increasing CO₂ feed. Hydrogen feed to the reactor is provided by methane and, to the extent methane feed is low or zero, molecular hydrogen. Where hydrogen availability is varying, such a plant can be operated maximizing utilization of all capacity by adjusting the other feeds to maintain syngas production at a maximum possible amount.

As described above, an electric Tri-converter reactor, like the reactor 102, can be controlled in swing plants like the processes 100 and 200 by measuring mass flow and composition of the streams providing material to the reactor to control composition of the reaction mixture in the reactor. A temperature of each feed stream can be measured, and/or a temperature of the mixed gas entering the catalyst bed of the reactor can be measured. A controller such as the controller 120 can be configured to receive/resolve such measurements and to use a reactor model to calculate effluent composition of the gas based on the measured compositions and temperatures. Alternatively or additionally, the controller can be configured to compute a target temperature of the reaction required to achieve a target composition and to adjust the reaction temperature to the target temperature.

In some cases, mass flow rate and composition of the effluent gas of such a reactor can be ascertained, using the equipment of the processes 100 and 200, at the exit of the catalyst bed, or at a location downstream of the catalyst bed exit such as before a syngas cooler, before a condenser, and/of before an acid gas removal unit such as a CO₂ separator, any of which can be components of the conversion conditioner. A temperature of gas within or around the reactor can be ascertained by direct in-situ measurement using, for example, radiation-based thermal sensors. Alternatively or additionally, an exterior tube wall temperature of a tube of the reactor in which the reaction is performed can be measured and the internal gas temperature ascertained using a physical or statistical model. Heat input, for example average thermal flux and/or thermal flux profile, into the reactor can be controlled based on such temperature measurements and inferences. Where electrical heating components such as radiant heat sources are used to supply heat to the reactor, the controller herein can be operative coupled to the power supplies of such components to control power input, and thus thermal output, of such sources. The example of Table 1 illustrates how for the two different feeds, very different heat duties are required to operate the process in reactor 102 even while the exit temperature of the catalyst bed remains the same. In the case of the First Condition, a total heat duty for reactor 102 is 423 KW, comprising 248 KW from the reaction endotherm and 175 KW from sensible heat (associated with heating up the gas from the inlet temperature to the exit temperature). In the case of the Second Condition, a total heat duty for reactor 102 is 1759 KW, comprising 1491 KW from the reaction endotherm and 268 KW from sensible heat (associated with heating up the gas from the inlet temperature to the exit temperature). Such heat flows may be calculated using models based on the input gas flow rates, compositions, temperatures, and pressures.

Table 2 shows a similar case but where the two conditions yield the same output in product stream 132. This is accomplished by replacing the First Condition in Table 1 with twice the feed rate having the same composition.

TABLE 2
Conditions of Syngas Swing Plant

| | First Condition | | Second Condition | |
|---|---|---|---|---|
| H₂ Flow Rate (mtpd) | 3.7 | | 0 | |
| CO₂ Flow Rate (mtpd) | 26.2 | | 5.0 | |
| CH₄ Flow Rate (mtpd) | 0 | | 8.5 | |
| Steam Flow Rate (mtpd) | 3.7 | | 12.7 | |
| Syngas Rate (kmol/hr) | 136 | | 117 | |
| H₂ + CO Rate (kmol/hr) | 96.3 | | 96.8 | |
| Syngas H₂ + CO Mole Fraction | 0.708 | | 0.827 | |
| Syngas H₂:CO Molar Ratio | 2.09 | | 2.16 | |
| Reactor Hydraulic Demand | 100% | | 50% | |
| CO₂ Separation Demand | 100% | | 40% | |
| Electric Syngas Generation Unit | 846 | kW | 1759 | kW |
| 102 Heat Duty | | | | |
| Electric Syngas Generation Unit | 900 | C | 900 | C |
| 102 Catalyst Bed Exit | | | | |
| Temperature | | | | |
| Product 132 Output | 7.70 | mtpa | 7.70 | mtpa |

In this example, the conversion unit 118 has 100% capacity utilization in both conditions, and would similarly have 100% capacity utilization for any linear combination of conditions in between the First Condition and Second Condition, providing for a means to smoothly adapt to varying amounts of hydrogen by introducing the appropriate amounts of methane and appropriate controlling the amounts of steam and carbon dioxide. In this case, reactor 102 hydraulic demand is 100% and 50% of the design capacity in the First Condition and Second Condition respectively, and the CO₂ separation demand is 100% and 40% od the design capacity in the First Condition and Second Condition respectively. Therefore, it is noteworthy that there is an engineering tradeoff of optimizing for the capacity utilization of the conversion unit 118, but having reduced capacity utilization for other elements of the overall plant. As before, it is also again the case that the heat duty of reactor 102 is different in the two cases, in spite of the exit temperature of the catalyst bed being the same. As a result, it would also be desired to adjust the amount of heat delivered to the reactor 102 continuously as the feed conditions change between the First Condition and the Second Condition.

Where availability of hydrogen is limited, the controller herein can be configured to operate a plant like the process 100 or 200 to maximize use of the available hydrogen. The controller can also optimize for high plant utilization, for example, high utilization of conversion unit 132, for example, by introducing methane in place of hydrogen and adjusting steam and carbon dioxide accordingly. A reactor model can be used to compute reaction conditions, temperature, pressure, and composition that result in consumption of hydrogen near the availability of hydrogen, for example within a tolerance of the availability of hydrogen, which can be defined by a user or by a controller. The controller can be configured to use the reactor model to compute reaction temperature and composition that results in syngas having a target composition, based on the availability of hydrogen. The controller can be configured to use the reactor model to compute heat flow or heat duty into the reactor 102 that results in syngas having a target composition, based on the availability of hydrogen. The controller can be configured to adjust the heat flow or heat duty to maintain a target temperature in the reactor 102 or in the gas downstream of reactor 102, for example via sensors 124 or 128.

A reactor like the reactor 102 can be operated using various flow, temperature, and pressure sensors located along and within the reactor 102. Flow rates of reactant species to the syngas stage 127 can be ascertained using mass flow, composition, temperature, and pressure measurements for each of the streams 101, 103, 104, 105, 140, and 141 that flow to the syngas stage 127. The sensor unit 125 can include temperature, pressure, mass flow, and composition sensors to provide signals representing such conditions of the gas entering the reactor 102, and the controller 120 can be configured to receive and interpret such signals. The sensor unit 124 can include mass flow, composition, temperature, and pressure sensors to provide signals representing such conditions of the gas flowing within the reactor 102, i.e. into the catalyst bed of the reactor 102, through the catalyst bed of the reactor 102, and/or at the exit of the catalyst bed of the reactor 102. The sensor unit 128 can also include mass flow, composition, temperature, and pressure sensors. Where the sensor unit 124 has sensors located at the exit of the catalyst bed of the reactor 102, it can be inferred that the composition of the gas at the location of the sensor unit 128 will be the same as that exiting the catalyst bed of the reactor 102 if the exiting gas has not yet been cooled and/or subjected to condensation. In such cases, the sensor unit 128 can omit a composition sensor. Alternatively, a composition sensor in the sensor unit 124 can be omitted if the sensor unit 128 has a composition sensor. Where the sensor unit 128 is located downstream of a composition changing operation, such as cooling and/or condensation, the sensor unit 128 can include a composition sensor to provide signals from which a change in composition of the gas can be ascertained by the controller 120.

Thus, the sensor unit 124 can include one or more temperature sensors located within the catalyst bed of the reactor 120 to provide signals representing a temperature of the the catalyst bed and/or the gas in catalyst bed, optionally at a plurality of locations within the catalyst bed. Alternatively or additionally, the sensor unit can include one or more temperature sensors located within the reactor 102, for example along an interior wall of one or more tubes holding catalyst, to provide signals representing a temperature of the gas flowing through the catalyst bed and/or the reactor tube wall, optionally at a plurality of locations within the reactor 102. Alternatively or additionally, the sensor unit 124 can include one or more temperature sensors located within the reactor 102 at an exit of the catalyst bed, optionally at a plurality of locations, to provide signals representing a final reaction temperature of the catalyst bed and/or the gas. Alternatively or additionally, the sensor unit 124 can include one or more temperature sensors located on an exterior wall of a tube within the reactor 102 that contains catalyst to provide signals representing a temperature of a tube wall exterior of the reactor 102, optionally at a plurality of locations within the reactor 102, from which thermal conditions within the catalyst tube (e.g. the interior catalyst tube wall temperature, the catalyst bed temperature, and/or the gas temperature) can be ascertained by the controller 120 configured to use a thermal model. The sensor unit 128, located downstream of the reactor 102, optionally after a composition changing operation such as cooling and/or condensation, can also include one or more temperature sensors to provide signals representing a temperature of the material, gas and/or liquid, flowing downstream of the reactor 102. The controller 120 can be configured to receive signals from such sensors, to ascertain temperatures or other thermal conditions (such as thermal flux) from such sensors and to use a reaction model to evaluate the operation of the reactor 102 based on such sensors, for example by computing an implied heat duty of the reactor 102 based on component conversions of the input gas feed into the output gas feed and process conditions ascertained from the signals provided by the various sensor units.

The reaction models described herein can be standard Gibbs reactor models available in commercial chemical modeling software. Such a model allows calculation of inputs, such as feed compositions, feed flow rates, and reaction conditions (temperature and pressure), to give outputs, such as outlet compositions and flow rates. Alternatively or additionally, the reaction models allow inputs, such as feed compositions and flow rates and outlet compositions and flow rates, to yield outputs such as reaction conditions that result in such outlet compositions and flow rates. Gas law computations can be used, with sensed temperatures and pressures, to infer concentration of species at different locations (having different thermodynamic conditions), for example at the location a temperature measurement is taken, in order to accurately infer gas composition at the location of the temperature measurement. The reaction model can also contain empirical adjustments, which can be derived based on historical practice and/or experimentally measured values, for example using statistical models or by other means.

The signals provided by the sensors described above can be used by the controller 120, configured to use a reactor model such as that described above, to adjust flow controllers such as the controllers 111-114, 119, 134, and 143, along with heat input to the reactor 102, to achieve a desired outlet gas composition and flow rate. The controller 120 can be configured to adjust electrical energy provided to electrical heating elements of the reactor 102, where the reactor 102 uses electrical heating elements, to control process temperatures in a range that provides the desired outlet gas composition, based on computations using a reactor model such as that described above.

In one example, the controller 120 can be configured to adjust such heaters, or any suitable source of thermal energy coupled to the reactor 102, to achieve a target gas temperature at the exit of the reactor 102, or at the exit of the catalyst bed of the reactor 102, using signals from temperature sensors of the sensor unit 124 disposed at such locations. The controller 120 can be configured to, based on such temperature signals, control flow of the various feed streams to maintain or target an outlet gas composition and/or flow rate. The controller 120 can be configured to compare an outlet gas composition derived from signals obtained from the sensor unit 124 and/or the sensor unit 128, and to use the reactor model and sensed temperatures to compute and implement changes to feed composition that will achieve the target outlet gas composition.

Mass flow rates and compositions of the various feed streams can be ascertained by the controller 120 using sensors disposed at locations where a temperature of the various feeds is low (to allow use of equipment that would otherwise be compromised by the high temperatures nearer to the reactor 102). The controller 120 can be configured to sum the measured mass flows and to calculate compositions to infer total mass flow rate and species concentrations at the inlet to the reactor 102. Such measurements can avoid the need to use sensing equipment that is resistant to very high temperatures located, for example, at the inlet to the reactor 102 or within the reactor 102. Temperature and pressure of the gas exiting the catalyst bed, optionally along with composition, can also be ascertained by the controller 120, using appropriate sensors as described above, to completely resolve performance of the reactor 102.

In this example, to control the reactor 102, flow rates of each feed stream to the reactor 102 can be controlled by adjusting the controllers 111-114, 119, 134, and 143. Alternatively, the flow rates of all the feed streams except for one or both recycle streams can be controlled using the appropriate controllers. In such cases, the recycle stream flow rates and compositions can merely be sensed and ascertained by the controller 120.

The controller 120 can be configured to pursue a control target, using the sensor units and reactor models described above. For example, the controller 120 can be configured to maximize utilization of available hydrogen while producing a syngas product having a molar ratio of hydrogen to carbon monoxide that is within a target range and a total flow rate within a target range. The controller 120 can be configured, in this case, to control the composition of the gas before or after composition changing operations such as cooling and/or condensation based on a reaction formula that predicts the flow rate and composition of the gas after such operations depending on the total gas flow rate and composition of the feed to the reactor 102 and operating temperatures and pressures of the reactor 102, for example the temperature and pressure of the gas at, or just downstream from, the catalyst bed exit. For example, the reactor model can be configured as a formula that can be used to calculate (i.e. predict) thermodynamic equilibrium conversions of the inlet gas to the reactor 102 at the temperatures and pressures within the reactor 102 and the total heat flow or flux needed to achieve those calculated conversions at those temperatures and pressures.

The controller 120 can be configured to control an amount of thermal energy delivered to a catalyst bed within the reactor 102 to maintain a temperature within the reactor 102 near a target or within a target range. The temperature can be a temperature of gas within the reactor 102 at, near, or just downstream of an exit of the catalyst bed. The target temperature can be about 900 °C or the target range can be about 870 °C to about 930 °C. Alternatively, the target temperature can be about 750 °C, 800 °C, 850 °C or about 950 °C. Alternatively, the target range can about +/−5% of the target temperature, about +/−10% of the target temperature, or about +/−20% of the target temperature. Where electric heating elements are used to deliver thermal energy to the catalyst of the reactor 102, the controller 120 can be operatively coupled to electric heating elements, or power couplings for such elements, to control an amount of electric power delivered to each element. When the controller 120 determines that a signal provided by a temperature sensor of a sensor unit, such as the sensor unit 124, indicates a temperature of the reactor 102 is below a target temperature or temperature range, the controller 120 can be configured to increase electric power delivered to one or more electric heaters of the reactor 102, for example by adjusting a control element of the power supply coupled to the relevant electric heater. Likewise, the controller 120 can be configured to reduce power to one or more of the electric heaters of the reactor 102 when the temperature is above the target or target range. Where a combustion system is used to deliver the heat, the controller 120 can be configured to deliver more fuel to the combustion system if the temperature is below a desired temperature or range, or deliver less fuel to the combustion system if the temperature is above a desired temperature or range. The controller 120 can be configured to use a reactor model to determine the target temperature or temperature range using a reactor model to compute the approximate thermodynamic equilibrium conversion of species of the input gases to the reactor 102 at temperatures and pressures derived from signals received from the sensors of sensor units such as the sensor unit 124 and the thermal flux required to maintain those conversions at the sensed temperatures, any of which may be an exit gas temperature.

In another example, control of the heater and feeds to the reactor 102 is based on a reactor model provided to the controller 120. In this example, the controller 120 is configured to ascertain the approximate thermodynamic equilibrium conversions, as in the first example above, along with the total thermal flux needed to achieve those conversions at the measured or inferred exit gas temperature. Whereas, in the first example above, delivery of thermal energy from heaters to the reactor 102 is based on comparing temperatures to a target temperature, optionally computed using the reactor model, in this example, the controller 120 is configured to adjust control elements of the power supply to the electric heaters, or fuel supply to the combustion heaters, to deliver the calculated thermal energy to the reactor 102. Like the example above, corrective action can be taken in this example if a temperature, such as the exit gas temperature at or just downstream of the catalyst bed, departs from a target or target range or if a deviation of the modeled outlet temperature from the actual outlet temperature rises above a tolerance. In this case, because the reaction model is relied upon to provide a target energy budget for the reactor 102, the reactor model can be adjusted to output an energy target that results in a temperature closer to the target or target range. Corrective actions can include heat input adjustments up or down to bring temperatures to target, if temperature is deviating from the target at operating conditions the reaction model predicts will result in the temperature at the target temperature. In an appropriately configured reactor 102, a temperature profile can be adjusted to adjust temperature and/or conversion observed in the reactor 102. Constants of the reaction model, such as energies and/or adjustment factors, can be re-computed. Alternatively, or additionally, accuracy of instruments sending signals to the controller 120 can be re-evaluated to determine whether any inputs to the reaction model are becoming less accurate. Finally, conditions such as feed impurity and catalyst deactivation can be investigated and addressed.

In other cases, the methods of the two examples above can be combined. The controller 120 can be configured to control heat input to the reactor 102 by comparing a temperature ascertained from a signal received from a sensor unit to a target temperature or temperature range and also to compare conversions of components while operating the reactor 102 at the various targets. If, in such cases, an actual conversion departs from a conversion predicted by the reaction model, corrective actions such as any of the above actions can be taken.

Methods described herein thus include performing a conversion process that converts a combination of methane, carbon dioxide, hydrogen, and water in an input gas to syngas in a direct conversion syngas reactor; determining an availability of hydrogen from renewable sources; providing hydrogen from renewable sources to the direct conversion syngas reactor in the input gas for the conversion process based on the availability; and controlling a thermal condition of the conversion process based on the availability. Determining an availability of hydrogen can be based on a pressure, a flow rate, or both, of a gas, containing the hydrogen, provided to the input gas. Controlling the thermal condition of the conversion process can be performed at least in part using a reaction model that includes the reaction enthalpy of at least a portion of the reactions occurring in the direct conversion syngas reactor. In these methods the thermal condition can be a temperature, a thermal flux, a temperature profile, a thermal flux profile, or a combination thereof. Controlling a thermal condition of the conversion process based on the availability can include inputting, into a reaction model, a first value representing an amount of methane in the direct conversion syngas reactor, a second value representing an amount of carbon dioxide in the direct conversion syngas reactor, a third value representing an amount of hydrogen in the direct conversion syngas reactor, a fourth value representing a temperature in the direct conversion syngas reactor, and a fifth value representing a pressure in the direct conversion syngas reactor, wherein the third value is derived at least in part from the availability of hydrogen.

These methods can also include controlling, in the input gas, a molar concentration of methane, carbon dioxide, and water, based on the availability of hydrogen, yielding at different times a a first and second composition, wherein each composition is controlled to produce syngas having a target composition and/or flow rate of the syngas. Controlling the thermal condition of the conversion process can include adjusting a thermal flux, a temperature, or both, of the conversion process based on the adjusted concentrations, wherein adjusting the thermal flux, a temperature, or both, comprises adjusting an amount of power delivered to a heat source, a temperature of the heat source, or both, and the heat source is configured to deliver heat to the conversion process. adjusting the thermal flux, the temperature, or both, of the conversion process can be performed at least in part using a reaction model to determine a target temperature, a target thermal flux, or both. Controlling a thermal condition of the conversion process can include maintaining a set point of the thermal condition and adjusting a thermal input to the reaction based on the availability of hydrogen.

The methods can include providing a first and second thermal flux from the heat source to the conversion process, wherein the first thermal flux is applied when the input gas has a first composition and the second thermal flux is applied when the input gas has a second composition, different from the first composition, the first composition has a higher molar percentage of hydrogen and lower molar percentage of methane than the second composition, and the second thermal flux is greater than the first thermal flux. Controlling the thermal condition of the conversion process can include maintaining an exit temperature of the conversion process, at an exit location of the direct conversion syngas reactor, that is within a specified range by adjusting the thermal flux from the heat source to the conversion process. The conversion process can be a thermocatalytic process that is performed in a catalyst bed within the direct conversion syngas reactor, the exit temperature is the temperature of the gas exiting the catalyst bed, and the specified range can be between 800 °C and 1000 °C. The heat source can be an electric heat source that converts electrical energy into heat that is delivered to the conversion process, a combustion heat source, or any suitable heat source. The first and second compositions can be controlled based on the availability of hydrogen so that: (a) the syngas has a molar ratio of hydrogen to carbon monoxide that is between 1.9 and 2.3; and (b) the syngas target flow rate is 50% to 80% to 90% to 100% to 110% to 150% of a target flow rate, or any value therebetween.

In the methods herein, providing hydrogen from renewable sources to the direct conversion syngas reactor in the input gas for the conversion process based on the availability of hydrogen can include defining a hydrogen target, based on the availability of hydrogen, for the input gas and controlling a flow of hydrogen to the input gas based on the target. In the methods herein, the availability of hydrogen can change such that an actual hydrogen composition or flow rate is below a hydrogen variance threshold equal to about 90% or 80% or 50% of the target hydrogen composition or flow rate, or any value therebetween. The availability of hydrogen can change during a 24 hour period such that the actual hydrogen composition or flow rate is initially above the hydrogen variance threshold, then below the hydrogen variance threshold, and then again above the hydrogen variance threshold.

The methods described herein can include performing a conversion process that converts a combination of methane, carbon dioxide, hydrogen, and water in an input gas to syngas in a direct conversion syngas reactor; determining an availability of hydrogen from renewable sources; determining a target concentration of methane, carbon dioxide, and water in the input gas to the direct conversion syngas reactor based on the availability of hydrogen; providing hydrogen from renewable sources to the direct conversion syngas reactor for the conversion process based on the availability; providing methane, carbon dioxide, and water to the direct conversion syngas reactor for the conversion process based on the target concentrations; and controlling a thermal condition of the conversion process based on the availability. In the methods herein, the controlling a thermal condition of the conversion process can include using a reaction model to determine a target temperature, thermal flux, or both, based on the availability of hydrogen and the target concentrations of methane, carbon dioxide, and water. The methods herein can also include determining the target concentration of methane, carbon dioxide, and water based on a target composition and flow rate of the syngas.

The methods herein can include performing a conversion process that converts a combination of methane, carbon dioxide, hydrogen, and water in an input gas to syngas in a direct conversion syngas reactor; determining an availability of hydrogen from renewable sources; determining a target concentration of methane, carbon dioxide, and water in the input gas to the direct conversion syngas reactor based on the availability of hydrogen and a target composition of the syngas; providing hydrogen from renewable sources to the direct conversion syngas reactor for the conversion process based on the availability; providing methane, carbon dioxide, and water to the direct conversion syngas reactor for the conversion process based on the target concentrations; using a reaction model to define a target thermal condition for the conversion process based on the target concentrations of methane, carbon dioxide, and water in the input gas and based on a target concentration in an effluent of the direct conversion syngas reactor; and controlling a thermal condition of the conversion process to the target thermal condition.

The methods herein can include performing a conversion process that converts a combination of methane, carbon dioxide, hydrogen, and water in an input gas to syngas in a direct conversion syngas reactor; determining an availability of hydrogen from renewable sources; determining a target concentration of methane, carbon dioxide, and water in the input gas to the direct conversion syngas reactor based on the availability of hydrogen and a target composition and flow rate of the syngas; providing hydrogen, up to a target hydrogen flow rate, from renewable sources to the direct conversion syngas reactor for the conversion process based on the availability; providing methane, carbon dioxide, and water to the direct conversion syngas reactor for the conversion process based on the target concentrations; and responding to a change in the availability of hydrogen by adjusting the target concentrations so as to produce the target composition and flow rate of the syngas.

The method herein can also include using a reaction model to determine a target thermal condition of the direct conversion syngas reactor, and controlling the thermal condition of the direct conversion syngas reactor to the target thermal condition. The conversion process can be operable to control the flow rate of the syngas and to control the composition of the syngas based on the target composition when the change in the availability of hydrogen results in a reduction in the hydrogen flow rate to 50% or less of the target hydrogen flow rate. The conversion process can be operable to control the flow rate of the syngas and to control the composition of the syngas based on the target composition when the change in the availability of hydrogen results in a reduction in the hydrogen flow rate to 10% of less of the target hydrogen flow rate.

While the foregoing is directed to embodiments of one or more inventions, other embodiments of such inventions not specifically described in the present disclosure may be devised without departing from the basic scope thereof, which is determined by the claims that follow.

1. A method, comprising:
performing a conversion process that converts a combination of methane, carbon dioxide, hydrogen, and water in an input gas to syngas in a direct conversion syngas reactor;
determining an availability of hydrogen from renewable sources;
providing hydrogen from renewable sources to the direct conversion syngas reactor in the input gas for the conversion process based on the availability; and
controlling a thermal condition of the conversion process based on the availability.

2. The method of claim 1, wherein the determining an availability of hydrogen is based on a pressure, a flow rate, or both, of a gas, containing the hydrogen, provided to the input gas.

3. The method of claim 1, wherein controlling the thermal condition of the conversion process is performed at least in part using a reaction model that includes the reaction enthalpy of at least a portion of the reactions occurring in the direct conversion syngas reactor.

4. The method of claim 1, wherein the thermal condition is a temperature, a thermal flux, a temperature profile, a thermal flux profile, or a combination thereof.

5. The method of claim 1, wherein the controlling a thermal condition of the conversion process based on the availability comprises inputting, into a reaction model, a first value representing an amount of methane in the direct conversion syngas reactor, a second value representing an amount of carbon dioxide in the direct conversion syngas reactor, a third value representing an amount of hydrogen in the direct conversion syngas reactor, a fourth value representing a temperature in the direct conversion syngas reactor, and a fifth value representing a pressure in the direct conversion syngas reactor, wherein the third value is derived at least in part from the availability of hydrogen.

6. The method of claim 1, further comprising controlling in the input gas a molar concentration of methane, carbon dioxide, and water, based on the availability of hydrogen, yielding at different times a a first and second composition, wherein each composition is controlled to produce syngas having a target composition and/or flow rate of the syngas.

7. The method of claim 6, wherein controlling the thermal condition of the conversion process comprises adjusting a thermal flux, a temperature, or both, of the conversion process based on the adjusted concentrations, wherein adjusting the thermal flux, a temperature, or both, comprises adjusting an amount of power delivered to a heat source, a temperature of the heat source, or both, and the heat source is configured to deliver heat to the conversion process.

8. The method of claim 7, wherein the adjusting the thermal flux, the temperature, or both, of the conversion process is performed at least in part using a reaction model to determine a target temperature, a target thermal flux, or both.

9. The method of claim 5, wherein the controlling a thermal condition of the conversion process comprises maintaining a set point of the thermal condition and adjusting a thermal input to the reaction based on the availability of hydrogen.

10. The method of claim 1, wherein providing hydrogen from renewable sources to the direct conversion syngas reactor in the input gas for the conversion process based on the availability comprises defining a hydrogen target, based on the availability of hydrogen, for the input gas and controlling a flow of hydrogen to the input gas based on the target.

11. The method of claim 10, wherein the availability of hydrogen changes such that the actual hydrogen composition or flow rate is below a hydrogen variance threshold equal to about 90%, 80%, 50%, or any value therebetween, of the target hydrogen composition or flow rate.

12. The method of claim 11, wherein the availability of hydrogen changes during a 24 hour period such that the actual hydrogen [composition or flow rate] is initially above the hydrogen variance threshold, then below the hydrogen variance threshold, and then again above the hydrogen variance threshold.

13. A method, comprising:
performing a conversion process that converts a combination of methane, carbon dioxide, hydrogen, and water in an input gas to syngas in a direct conversion syngas reactor;
determining an availability of hydrogen from renewable sources;
determining a target concentration of methane, carbon dioxide, and water in the input gas to the direct conversion syngas reactor based on the availability of hydrogen;
providing hydrogen from renewable sources to the direct conversion syngas reactor for the conversion process based on the availability;
providing methane, carbon dioxide, and water to the direct conversion syngas reactor for the conversion process based on the target concentrations; and
controlling a thermal condition of the conversion process based on the availability.

14. The method of claim 13, wherein the controlling a thermal condition of the conversion process comprises using a reaction model to determine a target temperature, thermal flux, or both, based on the availability of hydrogen and the target concentrations of methane, carbon dioxide, and water.

15. The method of claim 14, further comprising determining the target concentration of methane, carbon dioxide, and water based on a target composition and flow rate of the syngas.

16. A method, comprising:
performing a conversion process that converts a combination of methane, carbon dioxide, hydrogen, and water in an input gas to syngas in a direct conversion syngas reactor;
determining an availability of hydrogen from renewable sources;
determining a target concentration of methane, carbon dioxide, and water in the input gas to the direct conversion syngas reactor based on the availability of hydrogen and a target composition of the syngas;
providing hydrogen from renewable sources to the direct conversion syngas reactor for the conversion process based on the availability;
providing methane, carbon dioxide, and water to the direct conversion syngas reactor for the conversion process based on the target concentrations;
using a reaction model to define a target thermal condition for the conversion process based on the target concentrations of methane, carbon dioxide, and water in the input gas and based on a target concentration in an effluent of the direct conversion syngas reactor; and
controlling a thermal condition of the conversion process to the target thermal condition.

17. A method, comprising:
performing a conversion process that converts a combination of methane, carbon dioxide, hydrogen, and water in an input gas to syngas in a direct conversion syngas reactor;
determining an availability of hydrogen from renewable sources;
determining a target concentration of methane, carbon dioxide, and water in the input gas to the direct conversion syngas reactor based on the availability of hydrogen and a target composition and flow rate of the syngas;
providing hydrogen, up to a target hydrogen flow rate, from renewable sources to the direct conversion syngas reactor for the conversion process based on the availability;
providing methane, carbon dioxide, and water to the direct conversion syngas reactor for the conversion process based on the target concentrations; and
responding to a change in the availability of hydrogen by adjusting the target concentrations so as to produce the target composition and flow rate of the syngas.

18. The method of claim 17, further comprising using a reaction model to determine a target thermal condition of the direct conversion syngas reactor, and controlling the thermal condition of the direct conversion syngas reactor to the target thermal condition.

19. The method of claim 18, wherein the conversion process is operable to control the flow rate of the syngas and to control the composition of the syngas based on the target composition when the change in the availability of hydrogen results in a reduction in the hydrogen flow rate to 50% or less of the target hydrogen flow rate.

20. The method of claim 18, wherein the conversion process is operable to control the flow rate of the syngas and to control the composition of the syngas based on the target composition when the change in the availability of hydrogen results in a reduction in the hydrogen flow rate to 10% of less of the target hydrogen flow rate.

21. The method of claim 7, further comprising providing a first and second thermal flux from the heat source to the conversion process, wherein the first thermal flux is applied when the input gas has a first composition and the second thermal flux is applied when the input gas has a second composition, different from the first composition, the first composition has a higher molar percentage of hydrogen and lower molar percentage of methane than the second composition, and the second thermal flux is greater than the first thermal flux.

22. The method of claim 7, wherein controlling the thermal condition of the conversion process further comprises maintaining an exit temperature of the conversion process, at an exit location of the direct conversion syngas reactor, that is within a specified range by adjusting the thermal flux from the heat source to the conversion process.

23. The method of claim 22, wherein the conversion process is a thermocatalytic process performed in a catalyst bed within the direct conversion syngas reactor, the exit temperature is the temperature of the gas exiting the catalyst bed, and the specified range is between 800 °C and 1000 °C.

24. The method of claim 7, wherein the heat source is an electric heat source that converts electrical energy into heat that is delivered to the conversion process.

25. The method of claim 21, wherein the first and second compositions are controlled based on the availability of hydrogen so that: (a) the syngas has a molar ratio of hydrogen to carbon monoxide that is between 1.9 and 2.3; and (b) the syngas target flow rate is 50% to 80% to 90% to 100% to 110% to 150% of a target flow rate, or any value therebetween.
